(19) United States
(12) Patent Application Publication
(10) Pub. No.: US 2024/0219546 A1
(43) Pub. Date: Jul. 4, 2024

(54) ULTRASONIC RANGING DEVICE AND METHOD

(71) Applicant: Shenzhen Dauxi Vision Technologies Co., Ltd., Shenzhen (CN)

(72) Inventor: Qing Xiao, Shenzhen (CN)

(21) Appl. No.: 18/418,470

(22) Filed: Jan. 22, 2024

(30) Foreign Application Priority Data
Dec. 28, 2022 (CN) 202223606378.5
Jun. 2, 2023 (CN) 202321409153.2

(51) Int. Cl. G01S 7/521; G01S 15/86

(52) U.S. Cl. CPC G01S 7/521; G01S 15/86

(57) ABSTRACT

The present invention discloses an ultrasonic ranging device and method. The ultrasonic ranging device comprises a housing, at least two transducer cores, and at least one isolation component. The housing includes at least two spaced cavities, each for accommodating one of the at least two transducer cores. The isolation component is positioned at the rear end of the transducer cores and forms a predetermined gap by separating from the housing at the rear end of the transducer cores to isolate and attenuate vibrations interference between the two transducer cores. The at least one isolation component effectively addresses the interference issue between at least two transducer cores, such as the transmitting transducer core and the receiving transducer core, in extreme conditions (e.g., compression, low temperature).

### CROSS REFERENCE TO RELATED APPLICATIONS

The present application claims the benefit of Chinese Patent Application Nos. 202223606378.5 filed on Dec. 28, 2022 and 202321409153.2 filed on Jun. 2, 2023. All the above are hereby incorporated by reference in their entirety.

### FIELD

The present invention relates to the field of ranging technology, and more particularly, to an ultrasonic ranging device.

### BACKGROUND

Related ultrasonic ranging devices are primarily used in the field of transportation and robotics, and can be applied in vehicles, aircraft, or industrial robots, for example.

Ultrasonic ranging devices generally consist of transmitting probes and receiving probes, which are separated by an elastic material. This structure functions normally under regular conditions. However, in low-temperature conditions, the elastic material stiffens, causing the vibrational energy from the transmitting probe to be directly transmitted to the receiving probe, resulting in erroneous values.

In situations involving high-pressure water immersion or exposure to high-pressure water jets, the gap between the transmitting and receiving probes and the elastic material can become filled with water, leading to incorrect readings. Similarly, when subjected to compression, provided that the compression force is significant, or in conditions involving high-temperature expansion, the device may produce erroneous values, rendering the ultrasonic ranging device incapable of functioning correctly.

### SUMMARY

A technical problem to be solved by the present invention is providing an improved method for an ultrasonic ranging device.

A technical solution adopted by the present invention to solve the technical problem is, to provide an ultrasonic ranging device, wherein comprises a housing, at least two transducer cores, and at least one isolation component;
the housing includes at least two spaced cavities, each for accommodating one of the at least two transducer cores;
the isolation component is positioned at the rear end of the transducer cores and forms a predetermined gap by separating from the housing at the rear end of the transducer cores to isolate and attenuate vibrations interference between the two transducer cores.

A method for ultrasonic ranging is provided, wherein an ultrasonic sensor emits at least two emission waves with widths W1 and W2, respectively, and the time interval between the two emission waves is T0,
when the ultrasonic waves encounter an obstacle and reflect back, echoes with widths W1′ and W2′ are detected, and the time interval is T0′,
wherein it satisfies the condition that W1′/W2′ equals or approximates W1/W2; T0 equals or approximates T0′ for the echo to be recognized as a valid echo, where W1 or W2 is a random number between 1 microsecond and 2000 microseconds, and T0 is a random number between 100 microseconds and 3000 microseconds.

The implementation of the ultrasonic ranging device and method in the present invention provides the following beneficial effects: the isolating member is positioned at the end of the probe, creating a predetermined gap between the isolating member and the housing at the end of the probe. This effectively isolates and reduces vibrations between the two probes, such as the transmitting probe and the receiving probe, even in extreme conditions like compression and low-temperature environments.

### BRIEF DESCRIPTION OF THE DRAWINGS

Subject matter of the present invention will be described in even greater detail below based on the exemplary figures. In the accompanying drawings:

FIG. 1 is a three-dimensional structural diagram of an ultrasonic ranging device in one embodiment of the present invention;

FIG. 2 is another angle three-dimensional structural diagram of an ultrasonic ranging device in one embodiment of the present invention;

FIG. 3 is an exploded view of the ultrasonic ranging device in some embodiments of the present invention (excluding transmission lines);

FIG. 4 is a schematic illustration of the application of the isolation device in some embodiments of the present invention;

FIG. 5 is a schematic illustration of the application of the isolation device in some other embodiments of the present invention;

FIG. 6 is a schematic illustration of the application of the isolation device in some other embodiments of the present invention;

FIG. 7 is an exploded view of the ultrasonic ranging device in some embodiments of the present invention (excluding transmission lines);

FIG. 8 is a schematic illustration of the application of the isolation device in some other embodiments of the present invention;

FIG. 9 is a schematic illustration of the application of the isolation device in some other embodiments of the present invention;

FIG. 10 is a schematic illustration of the application of the isolation device in some other embodiments of the present invention;

FIG. 11 is a schematic illustration of filling material in the predetermined gap as shown in FIG. 10;

FIGS. 12 to 13 are structural schematic diagrams of the holder in some embodiments of the present invention;

FIGS. 14 to 15 are structural schematic diagrams of the holder and probe assembly in some embodiments of the present invention;

FIGS. 16 to 17 are structural schematic diagrams of the probe in some embodiments of the present invention;

FIGS. 18 to 19 are structural schematic diagrams of the housing in some embodiments of the present invention;

FIGS. 20 to 24 are schematic illustrations of the manufacturing method of the ultrasonic ranging device in some embodiments of the present invention;

FIG. 25 is the second structural schematic diagram of the ultrasonic ranging device in some embodiments of the present invention;

FIG. 26 is an exploded view of the ultrasonic ranging device shown in FIG. 25;

FIG. 27 is an internal structural schematic diagram of the ultrasonic ranging device shown in FIG. 25;

FIG. 28 is a partial structural schematic diagram of the ultrasonic ranging device shown in FIG. 25;

FIG. 29 is the third structural schematic diagram of the ultrasonic ranging device in some embodiments of the present invention;

FIG. 30 is an exploded view of the ultrasonic ranging device shown in FIG. 29;

FIG. 31 is another angle structural schematic diagram of the ultrasonic ranging device shown in FIG. 29;

FIG. 32 is a cross-sectional view A-A of the ultrasonic ranging device shown in FIG. 31;

FIG. 33 is a cross-sectional view B-B of the ultrasonic ranging device shown in FIG. 31;

FIG. 34 is a cross-sectional view C-C of the ultrasonic ranging device shown in FIG. 31;

FIG. 35 is an enlarged view at location M of the ultrasonic ranging device shown in FIG. 33;

FIG. 36 is an internal structural schematic diagram of the ultrasonic ranging device shown in FIG. 31;

FIG. 37 is a structural schematic diagram of the housing of the ultrasonic ranging device shown in FIG. 31;

FIG. 38 is a structural schematic diagram of the isolation device of the ultrasonic ranging device shown in FIG. 31;

FIG. 39 is a structural schematic diagram of the holder of the ultrasonic ranging device shown in FIG. 31;

FIG. 40 is the first structural schematic diagram of the anti-glue structure of the ultrasonic ranging device shown in FIG. 31;

FIG. 41 is the second structural schematic diagram of the anti-glue structure of the ultrasonic ranging device shown in FIG. 31.

FIG. 42 is the diagram of the ultrasonic ranging device transmitting and receiving through the same probe core.

FIG. 43 and FIG. 44 are the diagram of the ultrasonic ranging device transmitting and receiving through the ultrasonic transmitting transducer core and the ultrasonic receiving transducer core respectively.

### DETAILED DESCRIPTION

For better understanding of the technical features, objects and effects of the present invention, the specific embodiments of the present invention will be described in detail with reference to the accompanying drawings.

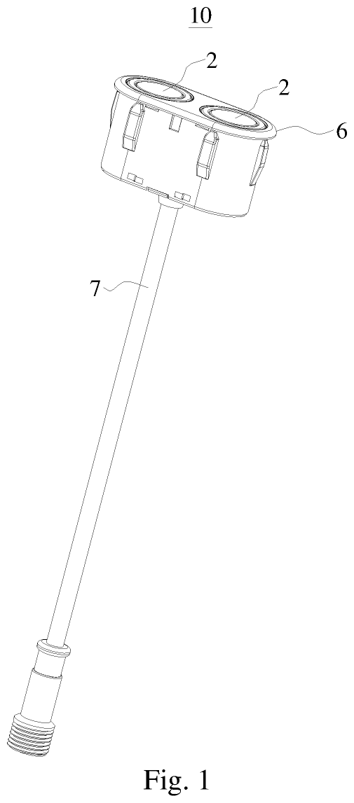

Please refer to FIGS. 1 through 6. The present invention discloses an ultrasonic ranging device comprising a housing 1, at least two probes 2, and at least one isolator 4.

The housing 1 consists of at least two spaced cavities 11, designed to individually accommodate at least two probes 2. The isolator 4 is positioned at the rear end of the probes 2 and creates a predetermined gap A between the isolator 4 and the housing 1 at the rear end of the probes 2, thus isolating and attenuating vibrations or interference between the two probes 2. This allows the ultrasonic ranging device to operate effectively even under extreme conditions such as compression, low temperature, high temperature, high-pressure water spray, or immersion in water.

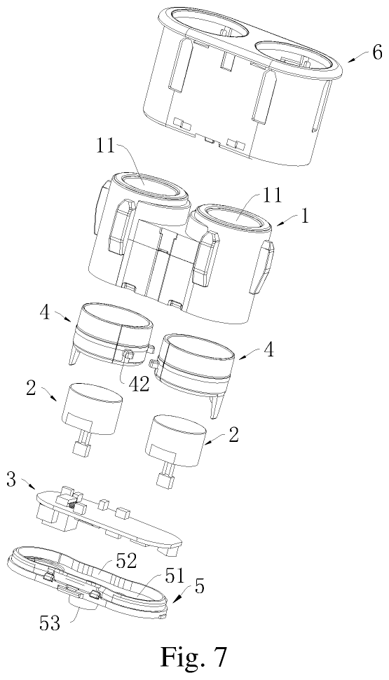

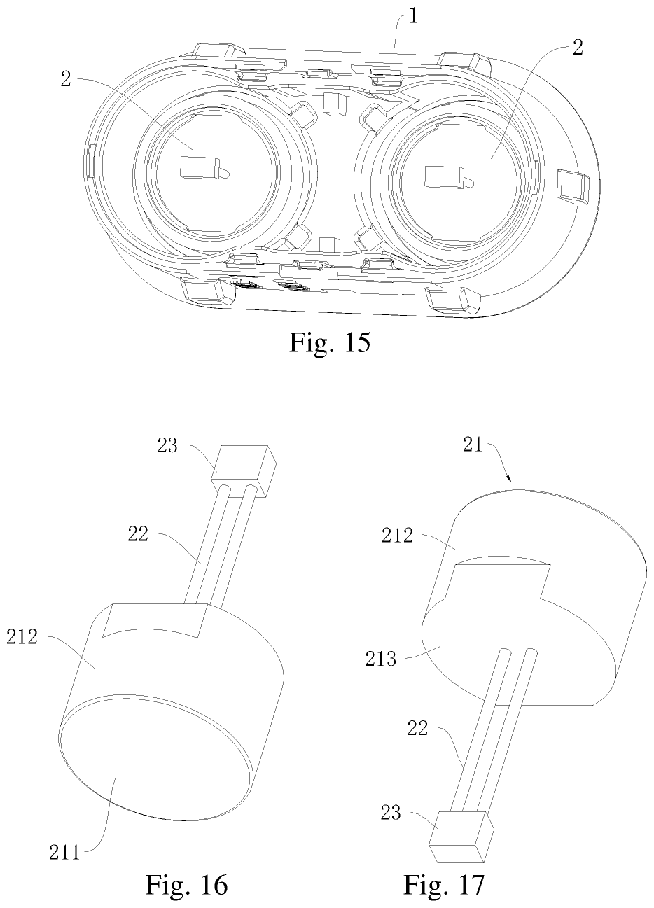

Please refer to FIGS. 7, 13 to 15. In some embodiments, the housing 1 can include an end wall 12, which extends into a circular peripheral wall 13. The end wall 12 forms at least two cavities 11 on it, with these cavities 11 being designed to encompass the entire or partial side and rear portions of the probes 2.

Preferably, an isolating part 15 is provided inside the end wall 12, and this isolating part 15 is used to separate at least two cavities 11. The isolating part 15 on one side has a groove 16, and correspondingly, the outer periphery of the isolator 4 can have protrusions 42. When the isolator 4 is installed into the housing 1, the protrusions 42 can be positioned within the grooves 16, preventing interference caused by the probes 2 moving back and forth.

Preferably, the grooves 16 on one side can be three in number, and each isolator 4 can have three corresponding protrusions 42.

Of course, the positions and quantities of the grooves 16 and protrusions 42 can be chosen based on practical needs, and in other embodiments, these grooves 16 and protrusions 42 may not be provided.

Preferably, the housing 1 can be made of a flexible material, such as silicone rubber, which can isolate a certain amount of vibration. Alternatively, the cavities 11 within the housing 1 can be made of a flexible or elastic material, while other parts can be made of plastic materials or other composite materials.

In some embodiments, the ultrasonic ranging device includes a circuit board 3, and the at least two probes 2 consist of an ultrasonic transmitting probe and an ultrasonic receiving probe, both of which are connected to the circuit board 3. Alternatively, the at least two probes 2 may consist of two ultrasonic transmitting probes and one ultrasonic receiving probe in combination, where the signals from the two ultrasonic transmitting probes are received by the same ultrasonic receiving probe. It is understood that the presence of isolator 4 can create a predetermined gap A between at least one ultrasonic transmitting probe or at least one ultrasonic receiving probe, and this predetermined gap A can be in the form of a hollow structure, designed to isolate and attenuate vibrational energy.

As shown in FIGS. 16 and 17, in some embodiments, each probe 2 may consist of a probe body 21 and a wire 22 connected to the probe body 21. One end of the wire 22, located away from the probe body 21, can have a connector 23 designed for connection to the circuit board 3 via a mating connector. The connector 23 can be a male connector, with the circuit board 3 having a corresponding female connector. Preferably, the probe body 21 includes an end portion 211, a side portion 212, and a tail portion 213. When the probe body 21 is installed within the cavity 11, the side portion 212 and tail portion 213 may contact the cavity's wall, with the end portion 211 protruding from the cavity 11 for signal transmission or reception. The end portion 211 functions as the ultrasonic emitting part, with ultrasonic emission being driven by piezoelectric ceramic vibration to produce ultrasonic waves by mechanically vibrating air molecules.

Preferably, the bottom of the cavity 11 is equipped with a first through-hole 111, and the isolator 4 is positioned opposite to the first through-hole 111. The empty space of the first through-hole 111 forms the predetermined gap A. Furthermore, the predetermined gap A can create a vacuum space, be filled with gas, or be filled with an elastic material.

In addition, the bottom of the isolator 4 is equipped with a second through-hole 41, and the wire 22 passes through the first through-hole 111 and then the second through-hole 41 in order to connect to the circuit board 3. The first through-hole 111 and/or the second through-hole 41 can be filled with sealing material, such as adhesive, to provide a seal. This can prevent the probes 2 from coming loose and falling out.

Referring again to FIGS. 1 to 6, the isolator 4 can have a plate-like structure and be fixed on the cavity 11 using adhesive, such as glue, or it can be fixed onto the cavity 11 using ultrasonic welding. The isolator 4 can be a single unit or there can be one or two isolators, with a preferred arrangement being two isolators, each set at the rear end of at least two probes 2. The two isolators 4 can be either independent units or an integral structure.

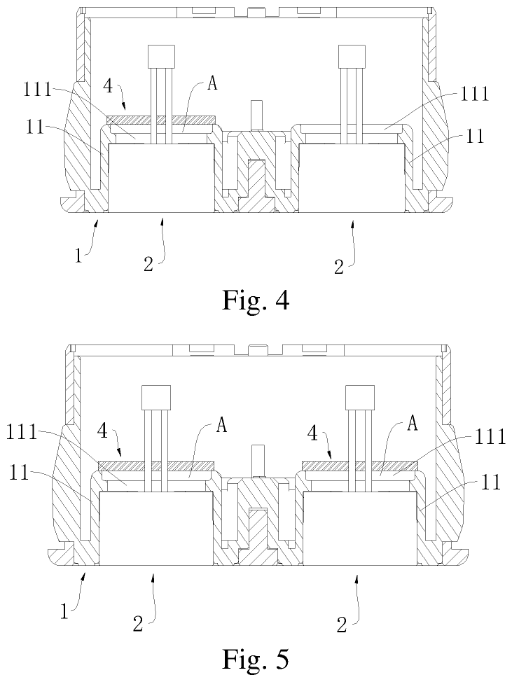

As shown in FIG. 4, in some embodiments, a single isolator 4 can be used, and it has a plate-like structure. This isolator is installed at the rear end of one of the probes 2, while the other probe 2 does not require the installation of an isolator. The isolator 4 can be positioned at the rear end of either the transmitting probe or the receiving probe.

As shown in FIG. 5, in some embodiments, two isolators 4 can be used, each set at the rear end of at least two probes 2. Preferably, these two isolators 4 are independently set and are both of a plate-like structure, being installed at the rear end of two separate probes 2. One isolator 4 can be positioned at the rear end of the transmitting probe, and the other isolator 4 can be positioned at the rear end of the receiving probe.

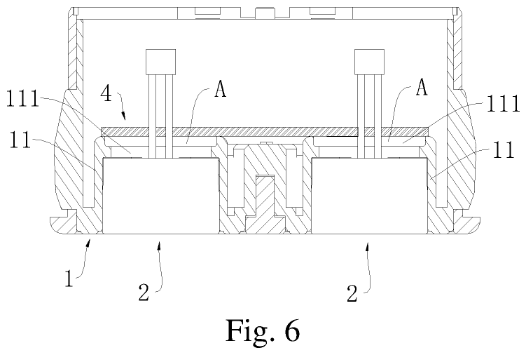

In FIG. 6, in some embodiments, two isolators 4 can be used as an integral structure and are installed at the rear end of two probes 2. It is understood that using an integral structure for the isolators 4 can help save assembly time.

Referring to FIGS. 7 to 12, in some embodiments, the isolator 4 has a cylindrical structure. The outer side walls of the cavity 11 are separated from the inner side walls of the isolator 4 by a predetermined gap, and/or the bottom wall of the cavity 11 is separated from the bottom wall of the isolator 4 by a predetermined gap A, with the bottom wall of the isolator 4 either abutting against the bottom wall of the cavity 11 or being spaced apart. The predetermined gap and gap A can be connected or unconnected, and the cross-sectional space formed by them can have a U-shape, L-shape, or I-shape.

Preferably, the isolator 4 has a cylindrical structure, or it can have a cup-like or round cup structure. It is fitted over the outer side walls of the cavity 11, and there is a certain gap maintained between the inner circumference of the isolator 4 and the outer circumference of the cavity 11. In other words, the inner circumference of the isolator 4 does not come into contact with the outer circumference of the cavity 11, effectively eliminating or attenuating vibrational energy from the rear and/or sides of the probes 2.

Preferably, the isolator 4 can be a single unit or there can be at least two of them. Ideally, there are two isolators 4, each set at the rear end of at least two probes 2. These two isolators 4 can be independent units, or they can be an integral structure.

In some embodiments, the predetermined gap A creates a vacuum space, is filled with gas, or is filled with an elastic material. The predetermined gap A can also be in the form of a vacuum space, be filled with gas, or be filled with an elastic material. It is understood that a vacuum space, ambient air, and an elastic material can all effectively reduce vibrational energy and minimize interference between one probe 2 and another probe 2.

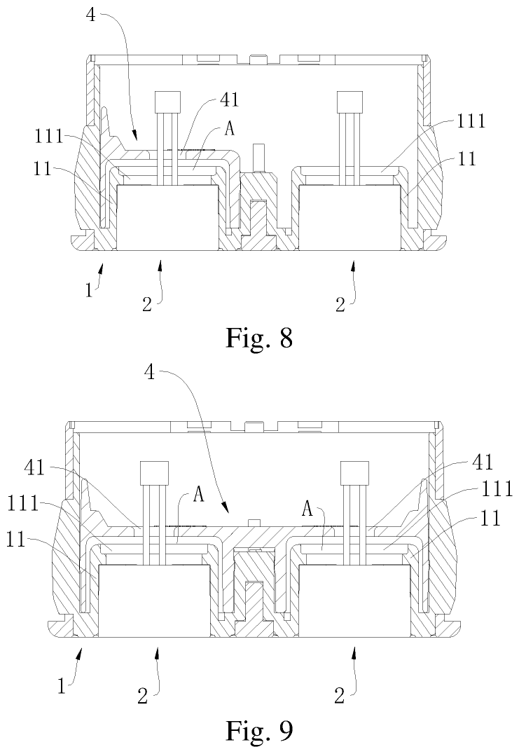

As shown in FIG. 8, in some embodiments, a single isolator 4 can be used. It has a cylindrical structure and is installed at the rear end of one of the probes 2. Specifically, the isolator 4 is fitted over the outer surface of a cavity 11, with at least some separation between the inner side walls of the isolator 4 and the outer side walls of the cavity 11, and/or a predetermined gap A between the bottom wall of the isolator 4 and the bottom wall of the cavity 11. It can be understood that the isolator 4 can either fully cover the outer surface of the cavity 11 while having a gap or remain completely detached from the outer surface of the cavity 11. This design effectively isolates vibrational interference between the sides and/or rear ends of one probe 2 from the sides and/or rear ends of another probe 2.

As shown in FIG. 9, in some embodiments, two isolators 4 can be used, and these isolators are an integral structure. They are installed at the rear end of two separate probes 2. Specifically, each isolator 4 is fitted over the outer surface of a corresponding cavity 11, with at least some separation between the inner side walls of each isolator 4 and the outer side walls of the corresponding cavity 11, and/or a predetermined gap A between the bottom wall of each isolator 4 and the bottom wall of the corresponding cavity 11. The integral structure of the isolators 4 can help save assembly time. Ideally, each isolator 4 does not come into contact with the outer surface of the cavity 11, completely isolating the vibrational transmission path between the sides and/or rear ends of one probe 2 from the sides and/or rear ends of another probe 2.

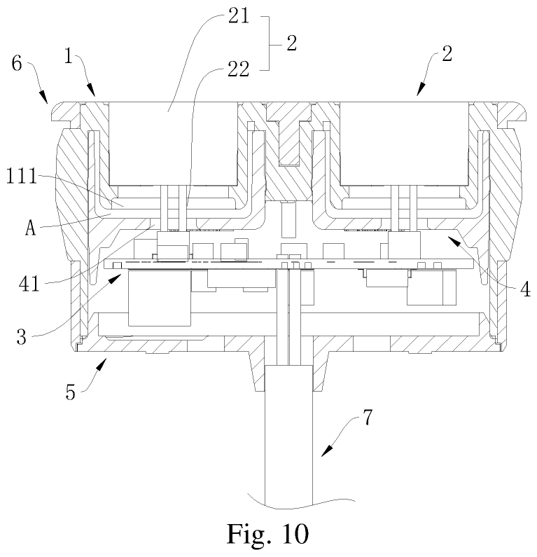

As shown in FIG. 10, in some embodiments, two isolators 4 can be used, and both isolators are independently set, each installed at the rear end of two separate probes 2. Specifically, each isolator 4 is fitted over the outer surface of a corresponding cavity 11, with at least some separation between the inner side walls of each isolator 4 and the outer side walls of the corresponding cavity 11, and/or a predetermined gap A between the bottom wall of each isolator 4 and the bottom wall of the corresponding cavity 11. Ideally, each isolator 4 does not come into contact with the outer surface of the cavity 11, completely isolating the vibrational transmission path between the sides and/or rear ends of one probe 2 from the sides and/or rear ends of another probe 2.

Through the analysis of the signals from the front end 211, side 212, and rear end 213 of the probe, it is observed that due to the conduction of mechanical vibrations, the vibrations generated by the high-frequency sound waves emitted from the front end 211 can be transmitted to the side 212 and/or rear end 213. Generally, the vibrations generated at the front end 211 when emitting high-frequency sound waves can be transmitted to the side 212 and rear end 213. Similarly, the front end 211, side 212, and rear end 213 of the receiving probe, when subjected to high-frequency vibrations, can convert these weak vibrations into weak millivolt-level electrical signals. The role of the isolator 4 is to use its U-shaped cup-like or cylindrical structure to isolate vibrations and prevent vibrations from being directly transmitted from the transmitting probe to the receiving probe, causing errors. Correctly triggered ultrasonic waves should encounter an obstacle in front of them before returning to be received by the receiving probe. By using the isolator 4, the acoustic transmission path of sound waves between the transmitting probe and the receiving probe at the side 212 or rear end 213 is completely isolated.

Furthermore, the cavities 11 of the housing 1 can encompass the transmitting probe and receiving probe. The transmitting probe is used to emit ultrasonic waves, while the receiving probe is used to receive the reflected ultrasonic waves. The cavities 11 envelop the side 212 and rear end 213 of the transmitting probe and also envelop the side 212 and rear end 213 of the receiving probe. This constitutes the first vibration isolation structure. In this configuration, the side walls of the cavities 11 are constrained by space, and their surfaces, such as the silicone walls, are very thin, which is insufficient to completely isolate the emitted waves from the transmitting probe or to fully block the received waves from the receiving probe.

Therefore, a second vibration isolation structure is further implemented, namely, the gap between the isolator 4 and the cavities 11, including the predetermined gap A and predetermined gap, surrounding the side 212 and rear end 213 of the transmitting probe or the side 212 and rear end 213 of the receiving probe to ensure that the emitted waves from the side 212 and rear end 213 of the transmitting probe are blocked by the gap. The principle used for blocking is buffering. The gap can be filled with air or an elastic material, or it can be a vacuum, to ensure that the emitted waves are buffered and isolated. By covering the outer periphery of the cavities 11 of the housing 1 with the isolator 4 and setting the gap (including the predetermined gap and predetermined gap), it effectively isolates the emitted waves, preventing them from being transmitted from the side 212 or rear end 213 of the transmitting probe to the receiving probe. This cleverly buffers and eliminates vibrations from the side 212 and/or rear end of the probe, ensuring high reliability.

Furthermore, in some embodiments, when the isolator 4 is of a cylindrical structure, the cavities 11 and the isolator 4 can be connected through a positioning structure. The positioning structure can include:

Several first positioning protrusions spaced circumferentially on the outer side wall of the cavities 11.

Several first positioning holes or slots on the wall surface of the isolator 4, spaced circumferentially and designed to match with the first positioning protrusions.

OR

Several second positioning holes or slots spaced circumferentially on the wall of the cavities 11.

Several second positioning protrusions on the inner wall surface of the isolator 4, designed to match with the second positioning holes or slots.

Of course, in other embodiments, the positioning structure can also take other forms, or in some cases, there may be no positioning structure at all.

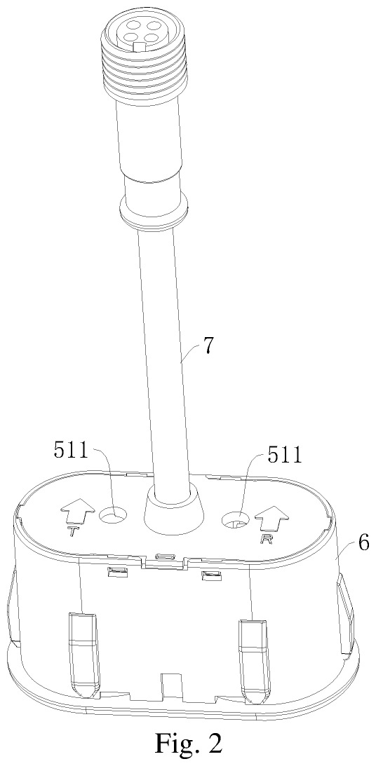

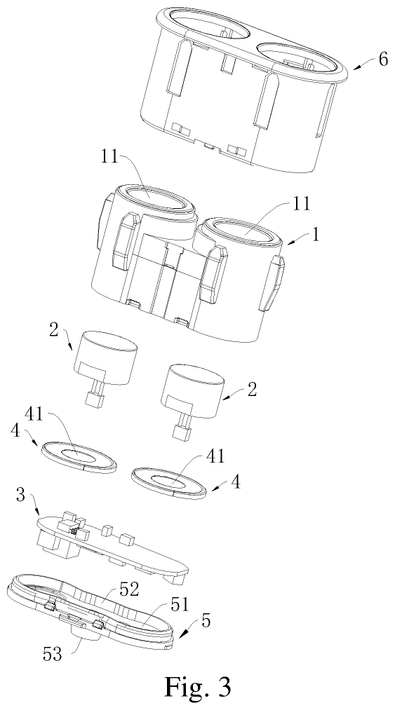

As shown in FIG. 2, FIG. 3, FIG. 7, In some embodiments, the ultrasonic ranging device also includes a base 5 for mounting the circuit board 3 and an outer shell 6. The isolator 4 is placed on the base 5, and the outer shell 6 is fitted over the periphery of the housing 1, isolator 4, and base 5.

In some embodiments, the base 5 can be connected to the outer shell 6 using various methods such as snap fastening, threaded connection, or interference fit.

Preferably, the base 5 includes a base plate 51 and a circumferential enclosure wall 52 extending from the base plate 51. The upper surface of the base plate 51 and the inner circumference of the enclosure wall 52 together form a housing space. Additionally, there may be several adhesive injection holes 511 on the base plate 51 to seal the entire ultrasonic ranging device after assembly by injecting sealing adhesive through these holes.

Preferably, the ultrasonic ranging device can also include a transmission line 7. There can be wire-through holes on the baseplate 51. One end of the transmission line 7 passes through the wire-through hole to connect with the circuit board 3. This connection can be achieved through connectors or by soldering, for example. Additionally, there can be guide portions 53 extending along the perimeter of the wire-through hole on the baseplate 51, and the transmission line 7 passes through these guide portions 53 to connect with the circuit board 3. The guide portions 53 provide guiding support.

In some embodiments, the outer shell 6 can be a cylindrical structure that includes a top wall 61 and a circumferential wall 62 extending from the top wall 61. The top wall 61 may have at least two apertures 611, which are spaced apart along the length of the outer shell 6. These apertures 611 allow the exposed ends 211 of at least two probes 2 to pass through.

Please refer to FIGS. 20 to 25. The present invention also discloses a method for manufacturing an ultrasonic ranging device, comprising the following steps:
S1: Install at least two probes 2 separately into the cavities 11 of the housing 1, and assemble the isolating member 4 at the tail end of the probes 2 to create a predetermined gap A between the isolating member 4 and the housing 1 at the tail end of the probes 2 to isolate and reduce vibration interference between the two probes 2.

Furthermore, the method includes the following steps:
S2: Lead out the wires 22 of the probes 2 from the first through-hole 111 at the bottom of the cavities 11 and fill the second through-hole 41 of the isolating member 4 with sealing glue using an automatic gluing machine.
S3: Connect the wires 22 to the circuit board 3.
S4: Assemble the housing 1, the isolating member 4, and the circuit board 3 into the base 5 and the shell 6.

In some embodiments, it may also involve first fitting the shell 6 with the housing (1) and then assembling the probes 2.

Specifically, it can involve first assembling the housing 1 inside the shell 6, and the assembled configuration is as shown in FIG. 20.

This manufacturing method ensures the effectiveness and precision of the assembly process, allowing the ultrasonic ranging device to operate reliably under various conditions.

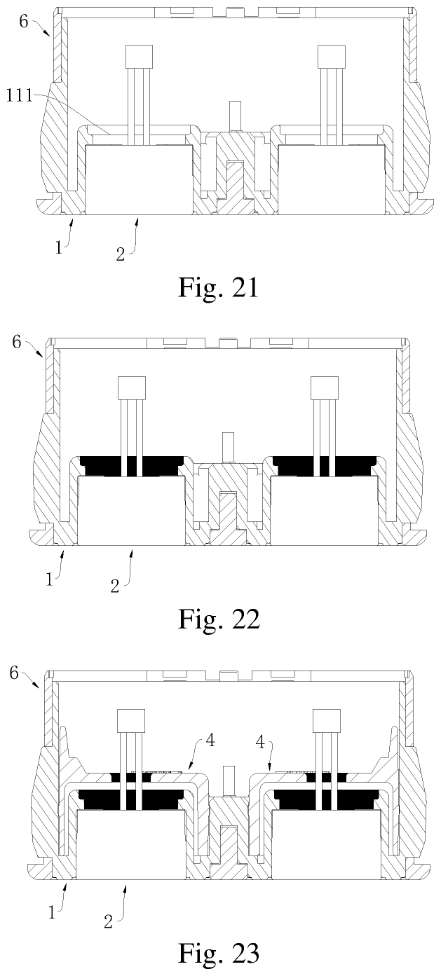

Next, insert at least two probes 2 into the two cavities 11 formed by the housing 1, creating a semi-finished product as shown in FIG. 21.

Then, mount the isolating member 4 to the bottom of the cavities 11. If the isolating member 4 is of a plate-like structure, there's no need to glue-seal the first through-hole 111 in the cavities 11. However, for improved sealing, you can choose to apply glue-seal to the first through-hole 111 in the cavities 11. This process can be done by arranging a large number of these semi-finished products neatly and applying glue seal using an automatic gluing machine. Subsequently, you can apply glue seal to the second through-hole 41 of the isolating member 4 to create a multi-layer seal. Once the glue has solidified, it ensures waterproofing and prevents the probes 2 from falling out.

If the isolating member 4 is of a cylindrical structure, you can first apply glue seal to the first through-hole 111 in the cavities 11, and then apply glue seal to the second through-hole 41 on the isolating member 4. Of course, you can also choose to apply glue seal only to the second through-hole 41. This process can also be carried out using an automatic gluing machine. Once the glue has solidified, it ensures waterproofing and prevents the probes 2 from falling out.

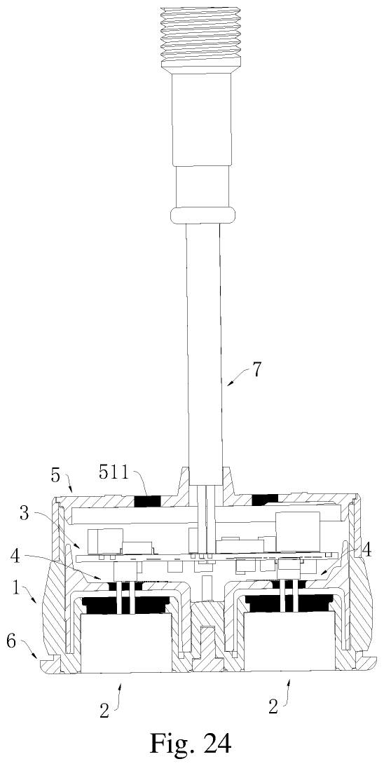

Assemble the circuit board 3 and connect the probes 2 to the circuit board 3. Thread the transmission line 7 through the base 5, and securely connect one end of the transmission line 7 to the circuit board 3. Assemble and secure the base 5 to the housing 6, forming the configuration shown in FIG. 24. For improved sealing performance, you can apply potting compound into the potting holes 511 on the base 5 to seal the entire ultrasonic ranging device 10.

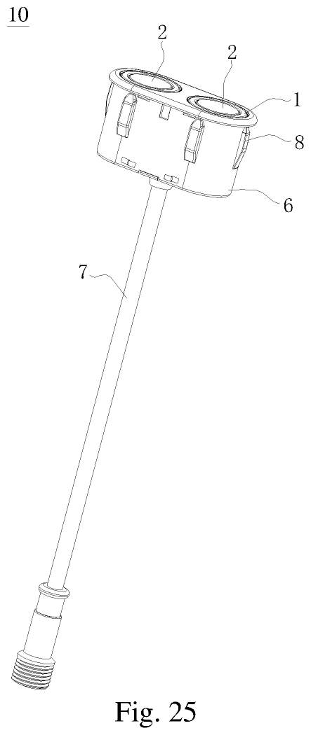

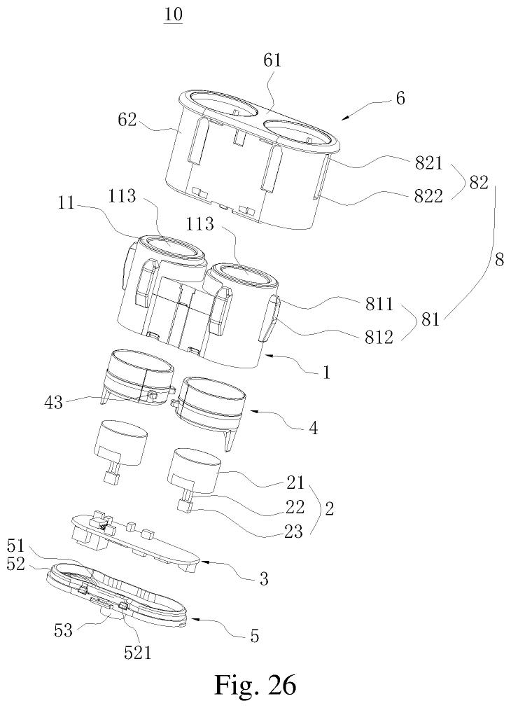

As shown in FIG. 25, in some other embodiments of the ultrasonic ranging device 10, it also includes a coupling structure 8. Additionally, refer to FIGS. 26 to 28. The coupling structure 8 comprises a coupling projection 81 and a coupling groove 82. One of the coupling projection 81 and coupling groove 82 is located on the housing 1, and the other is situated on the housing 6. The coupling projection 81 can be detachably engaged with the coupling groove 82.

In a comprehensible manner, the snap-fit structure 8 is employed to secure the relative positioning of housing component 1 and casing 6. The snap-fit protrusion 81 possesses a certain degree of elevation, with its contour aligning with the snap-fit groove 82. When mounting housing component 1 onto casing 6, the snap-fit protrusion 81 fits into the snap-fit groove 82 correspondingly. In doing so, the fixation of the relative positioning of casing 6 and housing component 1 is achieved. The snap-fit groove 82, together with the snap-fit protrusion 81, features a simple structure that is easy to manufacture and can be assembled automatically by machines. This enhances the assembly efficiency of the ultrasonic ranging device 10, thereby reducing manufacturing costs.

It should be noted that there are at least two possible configurations for the placement of the snap-fit protrusion 81 and the snap-fit groove 82. First, the snap-fit protrusion 81 can be positioned on the casing 6, while the snap-fit groove 82 is set on the housing component 1. Second, the snap-fit protrusion 81 can be located on the housing component 1, with the snap-fit groove 82 set on the casing 6.

Additionally, it is important to mention that the quantity of snap-fit protrusions 81 and snap-fit grooves 82 can be flexibly adjusted, with the numbers being set at one, two, three, four, five, six, or more. Preferably, the number of snap-fit protrusions 81 is configured to be equal to the number of snap-fit grooves 82, allowing for a one-to-one correspondence between the snap-fit protrusions 81 and the snap-fit grooves 82, thus ensuring a degree of foolproof installation.

As shown in FIGS. 26 to 28, in some embodiments of the ultrasonic ranging device 10, the housing 6 comprises a top wall 61 and an annular wall 62 extending from the top wall 61. The annular wall 62 is equipped with several snap-fit grooves 82, which are arranged at intervals along the periphery of the annular wall 62. Each snap-fit groove 82 consists of consecutively arranged contracting segments 821 and straight segments 822, with the contracting segments 821 positioned closer to one side of the top wall 61.

On the outer surface of the housing component 1, there are several snap-fit protrusions 81 designed to securely engage within the snap-fit grooves 82. Each snap-fit protrusion 81 includes consecutively arranged contracting sections 811 and straight sections 812, where the contracting sections 811 are designed to complement the contracting segments 821, and the straight sections 812 are designed to complement the straight segments 822.

In an understandable manner, the width of the slot at the contracting segments 821 of the snap-fit groove 82 is smaller than the width of the slot at the straight segments 822. Similarly, the width of the snap-fit protrusion 81 at the contracting sections 811 is narrower than the width at the straight sections 812. When the snap-fit protrusion 81 is inserted into the snap-fit groove 82, the contracting sections 811 fit into the contracting segments 821, and the straight sections 812 fit into the straight segments 822. As a result, the wider straight sections 812 cannot fit into the narrower contracting segments 821, which restricts the positioning of the straight sections 812 within the snap-fit groove 82. This, to a certain extent, further enhances the close fit between the snap-fit protrusion 81 and the snap-fit groove 82, improving the assembly precision of the product.

Preferably, the cross-sectional shape of the snap-fit groove 82 is the same as or similar to the cross-sectional shape of the snap-fit protrusion 81. More preferably, the cross-sectional dimensions of the snap-fit groove 82 are the same as or similar to the cross-sectional dimensions of the snap-fit protrusion 81 for ease of fitting.

Preferably, the snap-fit protrusion 81 and the snap-fit groove 82 can have an interference fit to secure them together.

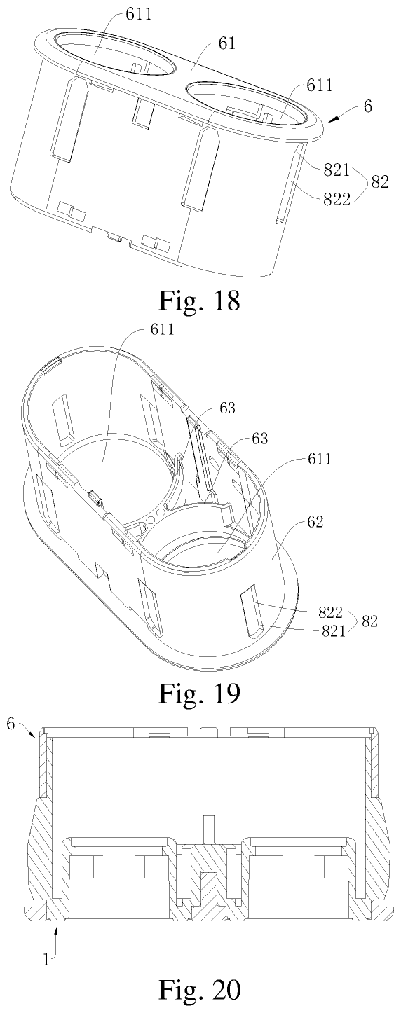

In other embodiments, reference may also be made to FIGS. 18 and 19, where the annular wall 62 is equipped with several snap-fit grooves 82, which are spaced at intervals along the circumference of the annular wall 62. Each snap-fit groove 82 consists of consecutively arranged contracting segments 821 and straight segments 822, with the contracting segments 821 positioned closer to one side of the top wall 61.

In some examples, the cross-section of the straight sections 812 is rectangular or elliptical. Preferably, the cross-section of the straight sections 812 is rectangular, and the cross-section of the aforementioned straight segments 822 can also be rectangular for case of assembly.

In some embodiments, both the housing 6 and the housing component 1 can be made from silicone material or another elastic insulating material. Of course, the choice of materials for the housing 6 and housing component 1 can be made based on practical requirements and is not specifically limited here.

In some embodiments, the housing component 1 comprises at least two cavities 11, each of which has an open end. At least two probes 2 are installed in these cavities 11. The inner wall surfaces of the cavities 11 near the open ends are smooth surfaces (designated as part 113 in FIG. 26).

As shown in FIGS. 26 to 28, in some embodiments of the ultrasonic ranging device 10, the inner wall surfaces of each cavity 11 have support ledges for the installation of the probes 2. The support ledges create a first passage B within the cavities, and the lower side of the support ledges forms a second passage C. The first passage B and the second passage C are in communication, creating a predetermined gap A.

Understandably, these support ledges delineate the internal space of each cavity 11 for probe installation and also provide the predetermined gap A to isolate or mitigate interference between the probes 2. The support ledges can form a continuous ring-like structure or be made up of multiple spaced block-like structures, with the multiple block-like structures distributed in a circular pattern.

In some embodiments, the housing component 1 also includes a circumferential wall 13 that connects to at least two cavities 11. The inner wall surface of this circumferential wall 13 is continuously smooth and continuous. The smooth, continuous inner wall surface of the circumferential wall 13 can reduce production costs and facilitate the installation of related components such as subsequent circuit boards 3. Preferably, the circumferential wall 13 can be a portion of the housing component 1's surface.

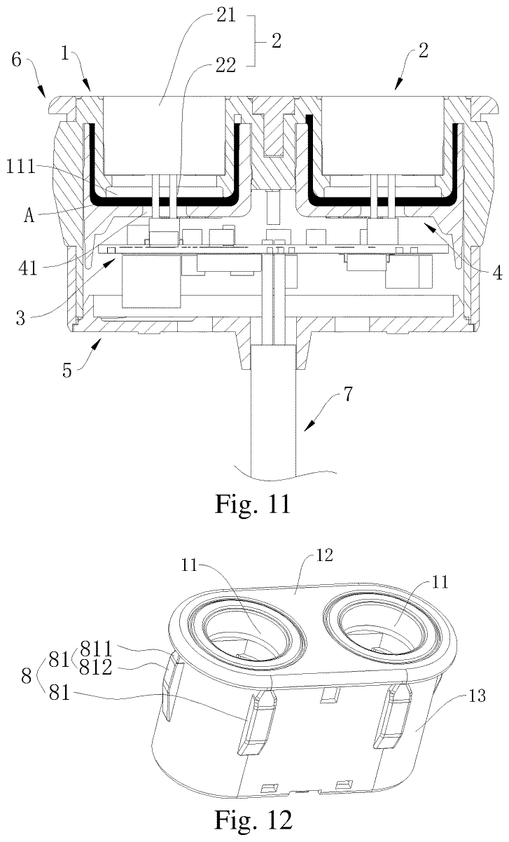

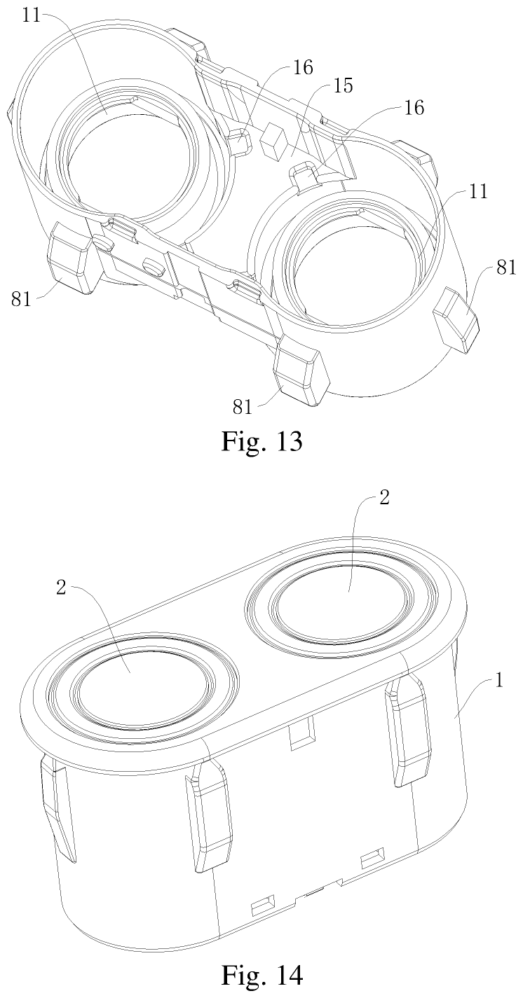

As shown in FIGS. 13 and 26, in some embodiments of the ultrasonic ranging device 10, the outer surface of the isolator 4 is equipped with positioning protrusions 43. Additionally, referring to FIG. 28, the housing component 1 also includes an isolating section 15 located between the two cavities 11. On the side facing each cavity 11, the isolating section 15 is provided with grooves 16 that complement the positioning protrusions 43.

Understandably, when the isolator 4 is installed around the periphery of the cavity 11, the positioning protrusions 43 align and engage with the grooves 16, limiting and positioning the installation angle of the probes 2. This prevents deviations and improves assembly precision. The placement and number of the positioning protrusions 43 and grooves 16 can be selected based on practical requirements and are not specifically limited here. Additionally, the positioning protrusions 43 can be configured symmetrically or asymmetrically, providing a certain degree of foolproofing when configured asymmetrically.

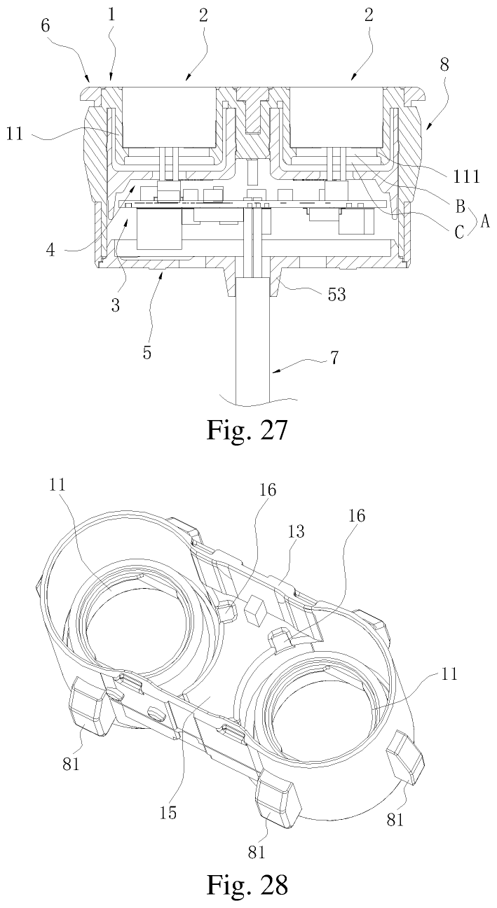

As shown in FIGS. 26 and 27, in some embodiments, the ultrasonic ranging device 10 also includes a base 5 designed to be mounted at the open end of the housing 6. The base 5 can be made of silicone or plastic material and typically has a cylindrical structure. The base 5 includes a base plate 51 and a surrounding wall 52 extending from the base plate 51. The surrounding wall 52 can have snap-fit parts to securely connect with the groove at the open end of the housing 6. Of course, the base 5 can also be assembled with the housing 6 through methods like threaded or snap-fit connections. The circuit board 3 can be mounted on this base 5.

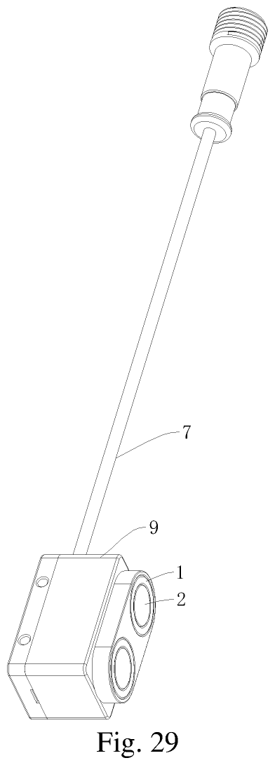

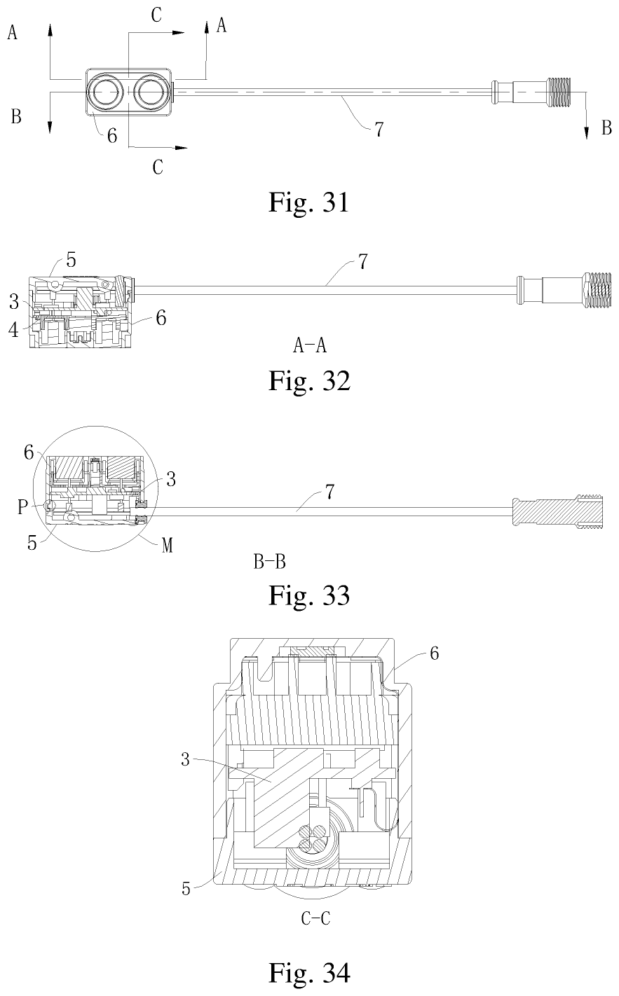

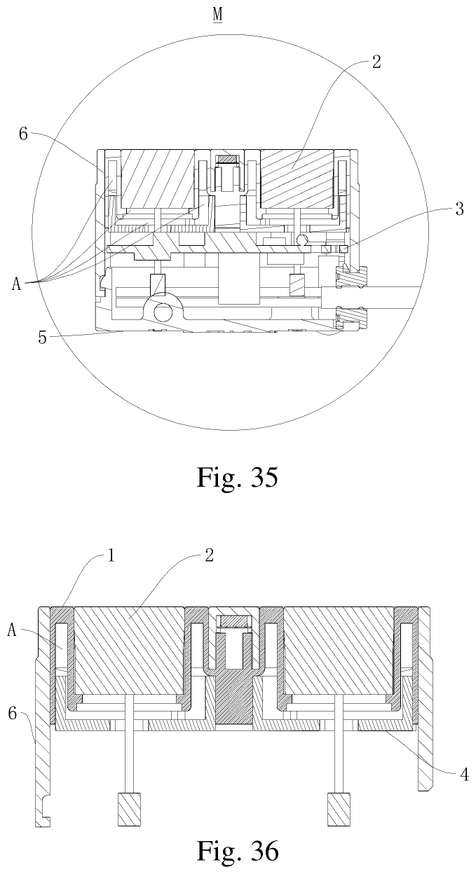

As shown in FIGS. 29 to 39, in some other embodiments of the ultrasonic ranging device 10, it includes a housing component 1, at least two probes 2, and at least one isolator 4. The housing component 1 consists of spaced cavities 11 designed to individually accommodate at least two probes 2. The isolator 4 is positioned at the rear end of the probes 2 and creates a predetermined gap A (as seen in FIG. 36) between the isolator 4 and the housing component 1 at the rear end of the probes 2. This gap isolates and reduces the interference of vibrations between the two probes 2.

Furthermore, in this embodiment, the ultrasonic ranging device 10 includes a housing 6 and a circuit board 3 positioned inside the housing 6. The housing component 1 is placed inside the housing 6, and the probes 2 pass through the housing component 1 and are electrically connected to the circuit board 3. The ultrasonic ranging device 10 also incorporates a laser ranging module 9, which is positioned between the housing 6 and the housing component 1, with the laser ranging module 9 located between the individual probes 2. The laser ranging module 9 can emit and receive laser beams through the housing 6 to the outside and calculate distance values using time-of-flight (TOF) or triangulation methods.

It can be understood that this embodiment integrates laser ranging with ultrasonic ranging to address issues related to transparent objects that cannot be detected by lasers and problems associated with tilted or sound-absorbing objects that ultrasonic sensors cannot measure. This integration eliminates the need for users to use both laser and ultrasonic ranging devices simultaneously and utilizes the combination of probes 2 and the laser ranging module 9 to address interference problems.

In this embodiment, the housing component 1, isolator 4, and circuit board 3 are installed inside the housing 6, facilitating adhesive fixation. Additionally, the isolator 4 is coordinated with the housing component 1, creating a first damping space surrounding at least two probes 2. By utilizing the isolator 4's isolation properties, it prevents the filling of adhesive during subsequent processes. The first damping space can form a hollow buffer structure to reduce vibration interference with the probes 2.

When one probe 2 generates vibrations during its operation and these vibrations are transmitted to the housing component 1, or when vibrations are transmitted to another probe 2 through the first damping space, they are significantly attenuated. This design prevents excessive residual vibrations from being directly transmitted through hard conduction to the probe itself or to another probe, reducing interference and ensuring accurate detection.

It can be understood that the at least two probes 2 include an ultrasonic receiving probe 2 and an ultrasonic transmitting probe 2, with both probes spaced apart. In this configuration, the isolator 4 can be two independent structures or a single integral structure, each enveloping the corresponding probe. Preferably, the isolator 4 consists of two independent structures, allowing the probes to be interchangeable. The isolators used for vibration isolation can also be interchangeable, reducing part variety and cost.

In this case, the laser ranging module 9 is connected to the circuit board 3 through an FPC (Flexible Printed Circuit) cable 101. The laser ranging module 9 is directly surface-mounted (SMT) and soldered to the FPC cable 101. The FPC cable 101 is routed along the inner wall of the housing 6 to reach the circuit board 3, where it can be connected via header pins, connectors, or direct soldering, allowing communication between the laser ranging module 9 and the circuit board 3. The circuit board 3 can directly obtain distance measurements from the laser ranging module 9.

In this embodiment, the laser ranging module 9, probes 2, and circuit board 3 communicate with each other through the I2C protocol. By combining ultrasonic and laser ranging, they complement each other and overcome limitations such as lasers not being able to measure highly transparent glass and ultrasonics being unable to measure soft and absorbent materials or surfaces at a certain angle. The laser ranging module 9 in this embodiment can be a sensor such as STMicroelectronics' VL53L0X, VL53L1X, VL53L2, VL53L3, VL53L4, VL53L5, or VISHAY's VCNL4040 infrared light sensor. It can also be another optical sensor or millimeter-wave radar sensor. The probes 2 are piezoelectric ceramic probes.

For example, with the VL53L0X sensor, the circuit board 3 is equipped with a microcontroller (MCU). The MCU communicates with the laser ranging chip VL53L0X, which is soldered onto the FPC cable via I2C, SPI, or another communication bus, to obtain laser distance data. The MCU also controls the ultrasonic transmission and reception and calculates the ultrasonic ranging data. The ultrasonic data is then compared with the laser ranging data.

It can be understood that in this embodiment, data is triggered simultaneously for both ultrasonic ranging and laser ranging. By obtaining data from both sources, if the laser ranging data is larger, then the ultrasonic distance data, or the set of data with the smaller return value, is used as the valid return data. Additionally, in multi-machine environments, since the data obtained from lasers has better resistance to interference, it is possible to prioritize the data returned by the laser ranging device. For example, when the laser rangefinder returns data of 1 meter and the ultrasonic returns data of 20 cm, and the ultrasonic data exhibits fluctuations, the ultrasonic data of 20 cm can be treated as noise and excluded. In cases where the ultrasonic data returns 20 cm twice, the laser data of 1 meter can be treated as noise and excluded, as it might indicate the presence of transparent glass.

This embodiment integrates laser ranging with ultrasonic ranging to address issues such as transparent objects that lasers cannot detect, tilted objects, or absorbent materials that ultrasonic sensors cannot measure. This integration eliminates the need for users to use a separate laser ranging device while also using an ultrasonic ranging device.

It's worth noting that to facilitate the laser emission and reception of the laser ranging module 9, at least the parts of the housing 6 corresponding to the laser ranging module 9 are made from laser-transmissive material. Preferably, the entire housing 6 is made from transparent or laser-transmissive material, such as materials that allow the passage of infrared or laser light.

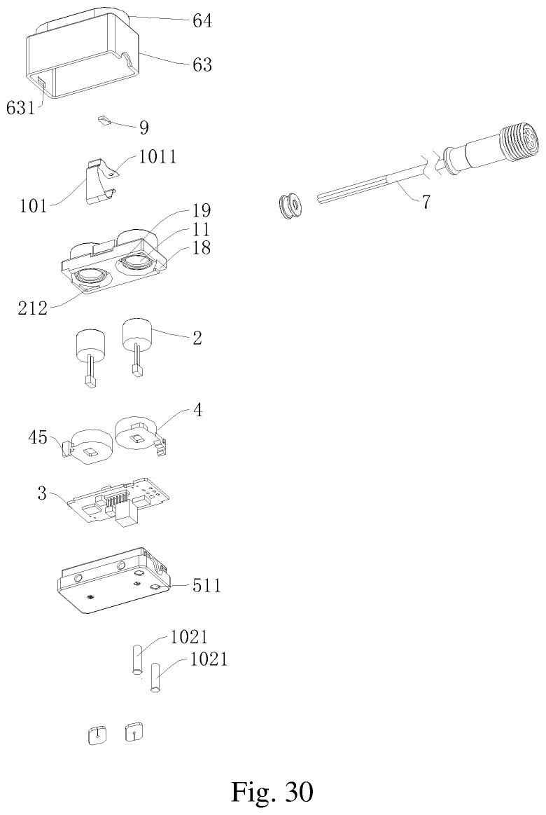

As shown in FIG. 30, the housing 6 comprises a bottom part called the first shell 63 and two second shells 64 that extend from one side of the first shell 63, forming a hollow structure, and they are integrally molded. The first shell 63 has a square structure, while the second shells 64 have a cylindrical structure and are spaced apart. The laser ranging module 9 is positioned between the two probes 2. The first shell 63 is used to mount part of the housing component 1, the isolator 4, and other structures, while the second shells 64 are used to accommodate another part of the housing component 1.

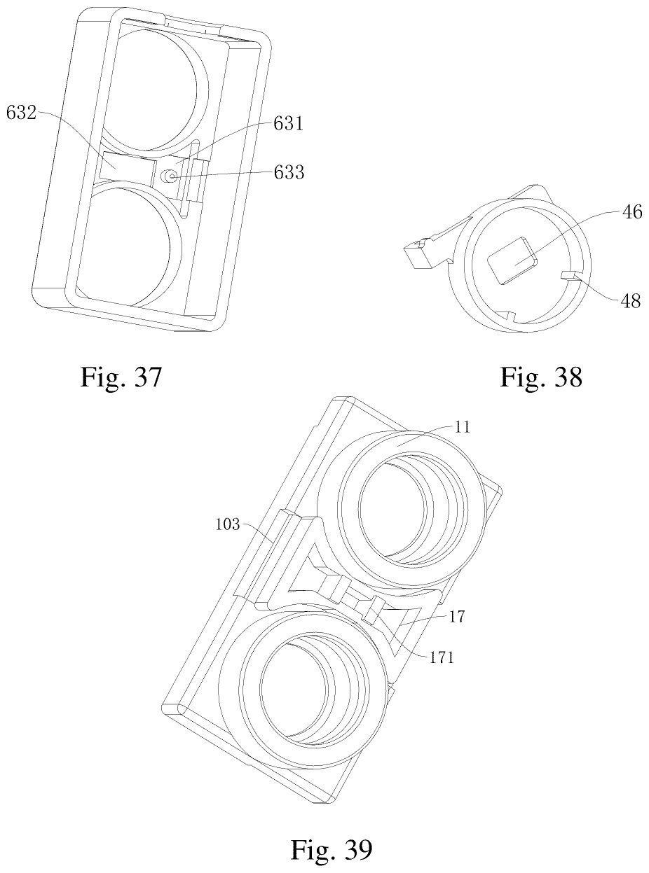

As shown in FIG. 37, in this embodiment, two second shells 64 are used as an example. The bottom wall of the first shell 63 has a mounting groove 632 formed between the two second shells 64, designed for the installation of the laser ranging module 9.

It can be understood that to facilitate the installation of the FPC cable 101, there is a groove structure 631 formed within the bottom wall of the first shell 63, and an installation groove 632 is formed within the bottom of the groove structure 631, which is used to accommodate the FPC cable 101.

To prevent the FPC cable 101 from moving during installation, positioning pillars 633 are set on the groove structure 631. Corresponding positioning holes 1011 are provided on the FPC cable 101, and by aligning these holes with the positioning pillars 633, the FPC cable 101 can be securely fixed in place.

As shown in FIG. 39, to accommodate the installation of the laser ranging module 9, the housing component 1 also features matching grooves 17. These matching grooves 17 extend outward from the side wall of the housing component 1 at corresponding positions and are aligned with the laser ranging module 9. The space between the matching groove 17 and the outer wall of the cavity 11 can be further increased, and the addition of this hollow structure enhances the vibration isolation between the two probes 2, thus improving measurement accuracy.

On the matching groove 17, there are positioning parts 171. These positioning parts 171 extend upwards from the bottom wall of the matching groove 17, with some protruding from the groove, to provide alignment for the FPC cable 101 and/or the laser ranging module 9. It can be understood that the positioning parts 171 may not necessarily come into contact with the bottom wall of the matching groove 17; as long as they serve the purpose of aligning the FPC cable 101 and/or the laser ranging module 9, they fulfill their role.

In this embodiment, there is a recessed slot 103 on the side of the housing component 1 facing the housing 6. This slot is used for aligning the installation of the housing 6 and also for accommodating the routing of the FPC cable 101.

As shown in FIG. 30, the housing component 1 also features annular recesses 19 located outside the cavities 11. These annular recesses 19 encircle the sides of the cavities 11, and one end of the isolation component 4 is mounted inside the corresponding annular recess 19. The other end of the isolation component 4 is connected to the circuit board 3 to press the housing component 1 against the housing 6. At least two probes 2 pass through the isolation component 4 and are electrically connected to the circuit board 3. The inner wall of the isolation component 4 and the outer wall of the cavities 11 form a first gap.

It should be noted that an annular recess 19 can be set outside each cavity 11, meaning that each annular recess 19 encircles one cavity 11. The cavities 11 are positioned inside the second housing 64, while the housing component 1 is inside the first housing 63. The isolation component 4 is installed within the annular recess 19, extending along the direction of the annular recess, allowing the isolation component 4 to fit directly above each probe 2. In this arrangement, one side of the isolation component 4 abuts the inner wall of the annular recess 19, thereby creating a first gap between the outer walls of the cavities 11. By using the hollow area created by the first gap to isolate vibrations, it effectively prevents unwanted reflections of ultrasound, avoids false measurements, and enhances the product's reliability.

As shown in FIG. 36, in some other embodiments, a second gap can also be set for damping at other locations on the product. Specifically, the isolation component 4 forms a second gap between it and at least two probes 2.

It is worth noting that either the first gap or the second gap can be set on the product, or both the first gap and the second gap can be set on the product simultaneously.

As shown in FIG. 30, in some embodiments, the outer wall of the isolation member 4 on one side extends outwardly to form a first limiting portion 44, and the accommodating member 1 on the side facing the circuit board 3 is formed with a first limiting groove 18 that matches the first limiting portion 44. This first limiting groove 18 is formed with a notch at one corner to accommodate the installation of the first limiting portion 44. When the isolation member 4 is installed within the annular cavity 19, the first limiting portion 44 abuts against the first limiting groove 18, providing a limiting function.

As shown in FIGS. 30 and 38, in some embodiments, one side of the isolation member 4 extends to form a latching portion 45. The latching portion 45 engages with the circuit board 3, making it easier to assemble the circuit board 3 to the isolation member 4. Simultaneously, the latching of the isolation member 4 and the circuit board 3 secures the accommodating member 1 to the housing 6 during installation, preventing the accommodating member 1 from moving or detaching.

Furthermore, the circuit board 3 is formed with latching positions 31 for the engagement of the latching portions 45. This ensures that the latching portions 45 are firmly secured to the circuit board 3, maintaining a close fit of the accommodating member 1 to the housing 6. In this embodiment, the latching portions 45 extend from one side of the first limiting portion 44 towards the side of the circuit board 3.

It is to be understood that in this embodiment, there is one latching portion 45 per isolation member 4, meaning that at least one latching portion 45 is provided for each isolation member 4 for connection with the circuit board 3. Additionally, it is possible to have two latching portions 45 arranged at intervals on a single isolation member 4, although this is not specifically limited.

The coordination of the isolation member 4 with the circuit board 3 serves to press the accommodating member 1 tightly against the housing 6. This coordination can involve methods such as using snap-fit relationships, interference fits, or adhesive bonding between the circuit board 3 and the housing 6.

As shown in FIG. 30, in some embodiments, the ultrasonic ranging device 10 further includes a light guide module 102. The light guide module 102 comprises a plurality of LED light sources connected to the circuit board 3 and light guide pillars 1021 positioned on the housing 6. Gluing holes 511 are provided in the housing 6, and the light guide pillars 1021 are inserted into these gluing holes 511, with each light guide pillar 1021 corresponding to an LED light source.

It is to be understood that the circuit board 3 can control the corresponding LED light sources to emit light. The light emitted by the LED light sources can be transmitted through the light guide pillars 1021 for user observation, allowing users to determine the current operational status of the product, among other things. The manner in which the circuit board 3 controls the LED light sources to emit light utilizes known drive structures in the prior art, enhancing the convenience of product use. It should be noted that after gluing is complete, in order to prevent unsightly appearances of the gluing holes 511, the insertion of the light guide pillars 1021 into the gluing holes 511 can seal them effectively.

As shown in FIG. 38, in some embodiments, the isolation members 4 are provided with apertures 46 for the passage of the probe cores 2, and these apertures 46 feature anti-gluing structures 47. It can be understood that the anti-gluing structures 47 are used to effectively block the intrusion of large molecular structures into the probe cores 2 and the inner wall of the housing 6, thereby enhancing the reliability of the ranging device.

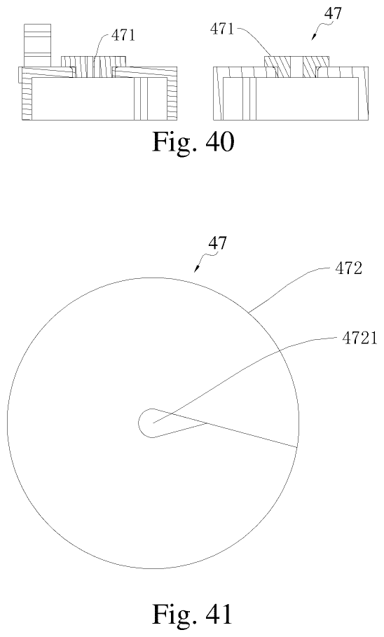

As shown in FIG. 40, in some embodiments, the anti-gluing structures 47 include silicone rubber covers 471. The silicone rubber covers 471 have an interference fit with the apertures 46 and feature a first slot.

It is to be understood that the interference fit serves to enhance the tightness of the fit between the silicone rubber covers 471 and the apertures 46, preventing the infiltration of the gel used for gluing and thus avoiding any impact on the damping effect of the designated gap A.

As shown in FIG. 41, in some other embodiments, the anti-gluing structure 47 includes at least one sticker 472 adhered to the apertures 46, and at least one sticker 472 has a second slot 4721.

It can be understood that the second slot is for the probe cores 2 to pass through. The shape of the sticker 472 can be square, circular, or polygonal, with a preferable choice being circular. The diameter size may range from 6-20 mm, with 10 mm being the preferred size. The second slot includes an arc segment and two straight segments extending outward from the ends of the arc segment and gradually approaching each other. This results in a shape similar to a weight scale pan (one end is arc-shaped, and the other end is pointed). The probe cores 2 can be moved to the center of this shape before adhering the sticker 472 to the apertures 46 on the isolation members 4. The stickers 472 are optimally applied in a layered manner, and the various second slots are coaxially aligned.

It should be noted that the gaps on the stickers 472 can also be replaced with parallel gaps, meaning the second slot includes an arc segment and two straight segments extending outward from the ends of the arc segment and positioned parallel to each other. The key is to ensure that the probe cores 2 can pass through and that it is convenient for later sealing. In some embodiments, more viscous high-molecular-weight adhesive can also be used to seal the apertures 46 directly.

As shown in FIG. 38, in some embodiments, there are multiple spaced prisms 48 inside the isolation members 4. During assembly, these prisms 48 come into contact with the housing 1, effectively limiting its movement and preventing it from rocking from side to side within the isolation members 4.

The present invention's ultrasonic ranging device 10 incorporates at least one isolation member to effectively ensure that even when manufacturing tolerances exist or when subjected to temperatures as low as −40° ° C. or pressure, it will not lead to malfunction. Furthermore, this at least one isolation member effectively addresses the issue of interference between at least two probes, such as the transmitting probe and the receiving probe, under extreme conditions (pressure, low temperature). This ensures that the ultrasonic ranging device 10 can achieve zero blind spot ranging while maintaining high reliability, fundamentally addressing the requirements for zero blind spot and high reliability in applications like automobiles, robots, and more. It is capable of adapting to various climates and extreme temperature variations and can achieve a high level of reliability, such as IP67 or higher, for waterproofing.

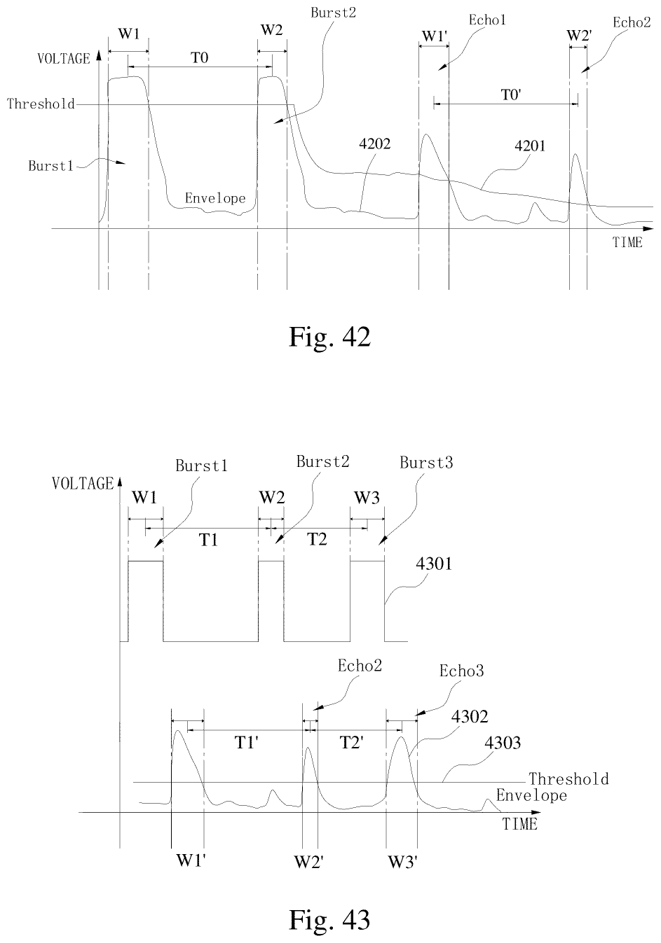

The effective isolation between the transmitting probe and the receiving probe allows the receiving probe to immediately detect the echo while the transmitting probe emits the wave. Therefore, it's possible to encode the transmitted waves, and the amplified echoes received will correspond to the encoding requirements, making them valid echoes. For example, let's consider a 40 kHz ultrasonic wave, as shown in FIG. 42, where Burst1 represents the first transmitted pulse, and Burst2 represents the second transmitted pulse. The Threshold is indicated by 4201, and the Envelope by 4202. Each pulse is 25 microseconds in duration. Burst1, for example, consists of 16 pulses, with a width labeled as W1, followed by Burst2, which consists of 8 pulses with a width labeled as W2, resulting in a total duration of 200 microseconds.

It is observed that the continuous pulse width is proportional to the width of the echo from the same obstacle, which is W1′ and W2′, with an interval of T0′. Therefore, the following relationship holds: W1′/W2′=W1/W2; and T0=T0′. Of course, due to errors and noise interference, when judging equality, it is generally considered that the two values are equal if they differ by 10% or 5%.

The three parameters, W1, W2, and T, can be encoded to achieve interference resistance in ultrasonic waves and avoid interference from ultrasonic waves of the same frequency. Specifically, W1 or W2 can be random numbers between 1 microsecond and 2000 microseconds, and T0 can be a random number between 100 microseconds and 3000 microseconds.

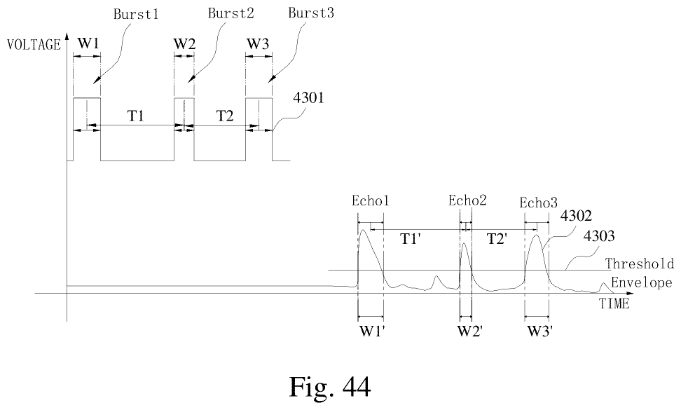

In FIG. 42, although encoding is possible, it has a blind zone within the probe's residual vibration. To overcome this, FIGS. 43 and 44 employ a separate transmitting probe and receiving probe. In these figures, 4301 represents 3 beams of transmitted waves, 4302 corresponds to the envelope of the 3 beams of echoes, and 4303 represents the threshold. Echoes below the threshold are considered invalid, while those above it are valid echoes.

Due to the isolation effect of this invention, the amplification factor of the receiving circuit of the receiving probe does not need to be set as a dynamic threshold, as in the prior art (a dynamic threshold that starts high and decreases). Instead, it can be set as a constant threshold, like 4303 (a horizontal line in the graph), to ensure that the proportion of received echoes will not be distorted.

The width of the transmitted waves is denoted as W1, W2, and W3, with intervals T1 and T2. The received echoes have widths W1′, W2′, W3′, and intervals T1′ and T2′. All five parameters—W1, W2, W3, T1, and T2—can be encoded. To resist interference and avoid interference from ultrasonic waves of the same frequency, W1, W2, or W3 can be random numbers between 1 microsecond and 2000 microseconds, and T1 or T2 can be random numbers between 100 microseconds and 3000 microseconds. The relationship between the echoes and the transmitted waves can be expressed by the following equation: W1′/W2′/W3′=W1/W2/W3; and T1=T1′, T2=T2′.

Using three transmitted waves provides better robustness when there is a significant amount of interference. In cases where not all of the above-mentioned relationship criteria are met within the echoes due to interference, partially meeting the conditions can still be considered as valid echoes. For example, sometimes interference waves partially overlap with W2′, causing W2′ to be wider. In such cases, the following relationships can be found: W1′/W3′=W1/W3 and T1+T2=T1′+T2′ If W2′ is within the estimated position range, it can also be considered a valid echo.

The hollow isolation structure in this invention allows for the global detection of echoes with encoding and the extraction of encoded information from them. It ensures that even at close distances, the sensor continues to use a lower threshold, resulting in greater sensitivity and improved close-range detection performance.

The implementation of this invention offers several beneficial effects:

The ultrasonic ranging device of this invention comprises a housing, at least two probes, and at least one isolating member. The housing contains at least two separate cavities, each intended for one of the probes. The isolating member is positioned at the end of the probe, creating a predetermined gap between the isolating member and the housing at the end of the probe. This effectively isolates and reduces vibrations between the two probes, such as the transmitting probe and the receiving probe, even in extreme conditions like compression and low-temperature environments.

This design ensures that the ultrasonic ranging device achieves zero-blind-zone ranging while maintaining high reliability. It fundamentally addresses the requirements for zero-blind-zone and high reliability in applications such as automobiles and robots. It is adaptable to various climates and extreme temperature differences. Simultaneously, it can achieve a high level of reliability in terms of waterproofing, including IP67 or higher.

The use of encoding for ultrasonic wave transmission, along with corresponding code detection of the echo, can also provide anti-interference effects. The encoding includes the following:

The ultrasonic sensor transmits at least two waves with different widths, denoted as W1 and W2.

These two transmitted waves are spaced apart by a time interval of T0.

When the ultrasonic waves encounter an obstacle and reflect back, the detected echoes have widths W1′ and W2′, and the time interval between them is T0′.

It is considered an effective echo if the ratio of W1′/W2′ is equal to or approximately equal to W1/W2, and T0 is equal to or approximately equal to T0′.

Here, W1 or W2 can be random values between 1 microsecond and 2000 microseconds, and T0 can be random values between 100 microseconds and 3000 microseconds. This encoding and detection method helps enhance the device's ability to resist interference.

It is understood that the above-mentioned technical features can be used in any combination without limitation.

While the present invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the present invention refer to an embodiment of the present invention and not necessarily all embodiments.

What is claimed is:

1. An ultrasonic ranging device, wherein comprises a housing, at least two transducer cores, and at least one isolation component;
wherein the housing includes at least two spaced cavities, each for accommodating one of the at least two transducer cores;
the isolation component is positioned at the rear end of the transducer cores and forms a predetermined gap by separating from the housing at the rear end of the transducer cores to isolate and attenuate vibrations interference between the two transducer cores.

2. The ultrasonic ranging device of claim 1, wherein the predetermined gap is filled with gas; or a vacuum space is formed within the predetermined gap; or the predetermined gap is filled with isolation potting compound.

3. The ultrasonic ranging device of claim 1, wherein the isolation component is plate-shaped;
the ultrasonic ranging device comprises two isolation components, and the two isolation components are correspondingly arranged at the rear end of the two transducer cores.

4. The ultrasonic ranging device of claim 1, wherein each of the isolation components is tubular, each of the isolation components is correspondingly fitted to the outer periphery of each of the cavities, and each of the isolation components, in conjunction with the housing, defines the predetermined gap.

5. The ultrasonic ranging device of claim 3, wherein each of the isolation components is integrally molded; and/or each of the isolation components is made of an elastic material.

6. The ultrasonic ranging device of claim 1, wherein the bottom of the cavities is provided with a first through-hole, the isolation component is set opposite to the first through-hole, and the cavity of the first through-hole forms the predetermined gap.

7. The ultrasonic ranging device of claim 1, wherein the ultrasonic ranging device comprises a circuit board;
wherein the transducer cores include an ultrasonic transmitting transducer core and an ultrasonic receiving transducer core, and both the ultrasonic transmitting transducer core and the ultrasonic receiving transducer core are connected to the circuit board.

8. The ultrasonic ranging device of claim 7, wherein the transducer cores include a transducer core body and wires connected to the transducer core body, and
the isolation component has a second through-hole, and the second through-hole corresponds to the first through-hole, the wires pass through the first through-hole and the second through-hole sequentially to connect to the circuit board, and the first through-hole and/or the second through-hole are filled with sealing material.

9. The ultrasonic ranging device of claim 7, wherein the ultrasonic ranging device further comprising a base and a housing for mounting the circuit board;
wherein the isolation component is placed on the base, and the housing is fitted around the housing component, the isolation component, and the base on the periphery.

10. The ultrasonic ranging device of claim 9, wherein the ultrasonic ranging device further comprising a clamping structure,
wherein the clamping structure includes clamping protrusions and clamping grooves, one of the clamping protrusions and clamping grooves is set on the housing component, and the other one is set on the housing, and the clamping protrusions can be detachably clamped within the clamping grooves.

11. The ultrasonic ranging device of claim 10, wherein the housing comprises a top wall and a surrounding wall extending from the top wall, and the surrounding wall has a plurality of the clamping grooves, and
each of the clamping grooves includes a series of contracting segments and straight segments, the contracting segments are positioned near the top wall;
the outer wall surface of the housing component has several clamping protrusions used for clamping within the clamping grooves, and
each of the clamping protrusions comprises a series of contracting parts and straight parts, the contracting parts are matched with the contracting segments, and the straight parts are matched with the straight segments.

12. The ultrasonic ranging device of claim 1, wherein the inner cavity wall of each of the cavities has support steps for mounting the transducer cores,
the inner cavity of the support steps forms a first passage, and the lower inner cavity of the support steps forms a second passage; the first passage is communicated with the second passage to form the predetermined gap.

13. The ultrasonic ranging device of claim 1, wherein the outer wall surface of the isolation component has limiting projections; and
the housing component further comprises an isolation part installed between the two cavities, and the isolation part on the side facing the cavities has grooves matching the limiting projections.

14. The ultrasonic ranging device of claim 1, wherein the ultrasonic ranging device further comprising a housing and a circuit board placed inside the housing,
the housing component is placed inside the housing, the transducer cores pass through the housing component and are electrically connected to the circuit board;
the ultrasonic ranging device further comprises a laser ranging module, and the laser ranging module is placed between the housing and the housing component, and the laser ranging module is located between the transducer cores; the laser ranging module can emit and receive lasers outward through the housing.

15. The ultrasonic ranging device of claim 14, wherein the housing component further has a circular cavity outside the cavities, one end of the isolation component is installed in the corresponding circular cavity, and the other end of the isolation component is connected to the circuit board to press the housing component onto the housing;
the at least two transducer cores pass through the isolation component and are electrically connected to the circuit board;
wherein, there is a first gap between the inner wall of the isolation component and the outer wall of the cavities, and/or there is a second gap between the isolation component and the at least two transducer cores.

16. The ultrasonic ranging device of claim 14, wherein one side of the isolation component extends to form a buckle part, and the buckle part clamps on the circuit board; or there are buckle positions on the circuit board for clamping the buckle parts.

17. The ultrasonic ranging device of claim 14, wherein the ultrasonic ranging device further comprising a light guide module, and the light guide module comprises several LED beads connected to the circuit board and light guide columns placed on the housing; there are potting holes on the housing, and the light guide columns are inserted into the potting holes, and the light guide columns correspond to the LED beads.

18. The ultrasonic ranging device of claim 14, wherein there are openings on the isolation component for the transducer cores to pass through, and there are anti-potting structures on the openings.

19. The ultrasonic ranging device of claim 18, wherein the anti-potting structures comprise silicone covers, and the silicone covers have an interference fit with the openings, and there are first through-holes on the silicone covers; or the anti-potting structures comprise at least one sticker adhered to the openings, and the at least one sticker has a second through-hole.

20. A method for ultrasonic ranging, wherein an ultrasonic sensor emits at least two emission waves with widths W1 and W2, respectively, and the time interval between the two emission waves is T0,
when the ultrasonic waves encounter an obstacle and reflect back, echoes with widths W1′ and W2′ are detected, and the time interval is T0′,
wherein it satisfies the condition that W1′/W2′ equals or approximates W1/W2; T0 equals or approximates T0′ for the echo to be recognized as a valid echo, where W1 or W2 is a random number between 1 microsecond and 2000 microseconds, and T0 is a random number between 100 microseconds and 3000 microseconds.
